(19) United States
(12) Patent Application Publication
(10) Pub. No.: US 2024/0399909 A1
(43) Pub. Date: Dec. 5, 2024

(54) Wireless Charging System for Railway Vehicles

(71) Applicant: Trackmobile LLC, LaGrange, GA (US)

(72) Inventor: Marco MATTIOLI, Modena (IT)

(73) Assignee: Trackmobile LLC, LaGrange, GA (US)

(21) Appl. No.: 18/680,716

(22) Filed: May 31, 2024

Related U.S. Application Data
(60) Provisional application No. 63/505,919, filed on Jun. 2, 2023.

(51) Int. Cl. B60L 53/30; B60L 53/124; B60L 53/38

(52) U.S. Cl. CPC B60L 53/32; B60L 53/124; B60L 53/38; B60L 2200/26

(57) ABSTRACT

A wireless charging system for charging a battery of a railway vehicle and a corresponding method of use are disclosed herein. The wireless charging system may comprise a fixed coil assembly installed between a set of tracks of a railway and a mobile coil assembly affixed to a bottom side of a railway vehicle (such as a locomotive or railcar mover). The fixed coil assembly may comprise at least one primary coil, and the mobile coil assembly may comprise at least one secondary coil. When the railway vehicle is positioned over the fixed coil assembly, electrical power may be transferred between the fixed coil assembly and the mobile coil assembly via the primary coil and the secondary coil to charge the railway vehicle. In various embodiments, electrical power may be transferred via the primary coil and the secondary coil without the primary coil physically contacting the secondary coil.

### RELATED APPLICATIONS

This application claims priority to U.S. Provisional Patent Application No. 63/505,919, filed Jun. 2, 2023, the content of which is hereby incorporated herein by reference in its entirety.

### FIELD OF THE DISCLOSURE

The present invention relates to the railway industry and, more particularly, to a wireless charging system for a railcar or railway vehicle.

### BACKGROUND

Wireless charging is the process where electrical energy is transmitted from a power source to an electrical load across an air gap using devices such as inductive coils. Wireless charging or wireless power transfer (WPT) offers convenience to operators in railway vehicles. It not only eliminates a manual operation of plugging and unplugging electrical equipment, but it also permits charging where grease, dust, or corrosion could prevent suitable electrical contact. In some cases, wireless charging may enable safer charging in a hazardous environment where an electrical spark could cause an explosion. Wireless charging can be durable and does not wear out the contacts on multiple insertions. However, most of the wireless charging systems or devices developed and available to date are primarily involved with and applicable to the automotive industry.

Conventional approaches to improving the power transfer efficiency require major infrastructure modifications. However, these approaches may be problematic for many in the railway industry for various reasons. Accordingly, there is a need for an improved system for wirelessly charging a railway vehicle that can be installed and used without necessitating modification(s) to the existing infrastructure.

### SUMMARY OF THE DISCLOSURE

Aspects of this disclosure relate to a wireless charging system for charging a battery of a railway vehicle and a corresponding method of use. The wireless charging system may comprise a fixed coil assembly installed between a set of tracks of a railway and a mobile coil assembly affixed to a bottom side of a railway vehicle. The railway vehicle may comprise a locomotive, a railcar mover, and/or another type of railway vehicle. In various embodiments, the fixed coil assembly may comprise at least one primary coil, and the mobile coil assembly may comprise at least one secondary coil. When the railway vehicle is positioned over the fixed coil assembly, electrical power may be transferred between the fixed coil assembly and the mobile coil assembly to charge the railway vehicle. In various embodiments, electrical power may be transferred via the primary coil and the secondary coil without the primary coil physically contacting the secondary coil.

In various embodiments, the fixed coil assembly may be detachably installed between the set of tracks. For example, the fixed coil assembly may be pressure mounted between the set of tracks of the railway. In some embodiments, the primary coil may be mounted on a base of the fixed coil assembly, and the fixed coil assembly may comprise one or more adjustment portions configured to adjust a position of the base between the set of tracks of the railway. In some implementations, the fixed coil assembly may further comprise mounting members configured to interface with an interior side of each of the set of tracks of the railway. In various embodiments, the secondary coil may be mounted on a base of the mobile coil assembly, and the mobile coil assembly may comprise one or more adjustment portions configured to adjust a position of the base relative to the bottom side of the railway vehicle. In various embodiments, the secondary coil may be suspended from the bottom side of the railway vehicle and oriented parallel to the primary coil. In some implementations, the mobile coil assembly may further comprise a brush configured to remove debris on a surface of the primary coil as a railway vehicle passes over a fixed coil assembly.

In various embodiments, when the railway vehicle is positioned over the fixed coil assembly, the mobile coil assembly may be configured to interface with or move within a proximity of the fixed coil assembly. For example, the fixed coil assembly and the mobile coil assembly may each comprise one or more slide portions. In such embodiments, at least one slide portion of the mobile coil assembly may be configured to engage at least one slide portion of the fixed coil assembly to adjust (or maintain) a distance between the primary coil and the secondary coil. In some embodiments, the primary coil of the fixed coil assembly may be oriented such that it faces upward away from the tracks of the railway. In such embodiments, the secondary coil may be oriented such that it faces downward away from the bottom side of the railway vehicle, and thus may face toward the primary coil. In other embodiments, the primary coil of the fixed coil assembly may be oriented such that it faces downward towards the tracks of the railway. In such embodiments, the secondary coil may be oriented such that it faces upward towards the bottom side of the railway vehicle, and thus may face toward the primary coil.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a perspective view of an example wireless charging system installed on a railway, according to one or more aspects described herein;

FIG. 2 depicts a front view of an example primary coil assembly installed between the tracks on a railway, according to one or more aspects described herein;

FIG. 3 depicts a side view of an example wireless charging system comprising a primary coil assembly installed between the tracks on a railway and a secondary coil assembly affixed to the bottom of a railway vehicle, according to one or more aspects described herein;

FIG. 4 depicts another side view of an example wireless charging system, according to one or more aspects described herein;

FIGS. 5A-E depict various views of an example wireless charging system, according to one or more aspects described herein;

FIG. 6 depicts a front view of an alternative embodiment of an example wireless charging system, according to one or more aspects described herein;

FIG. 7 illustrates an example of a process for wirelessly charging a battery of a railway vehicle, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

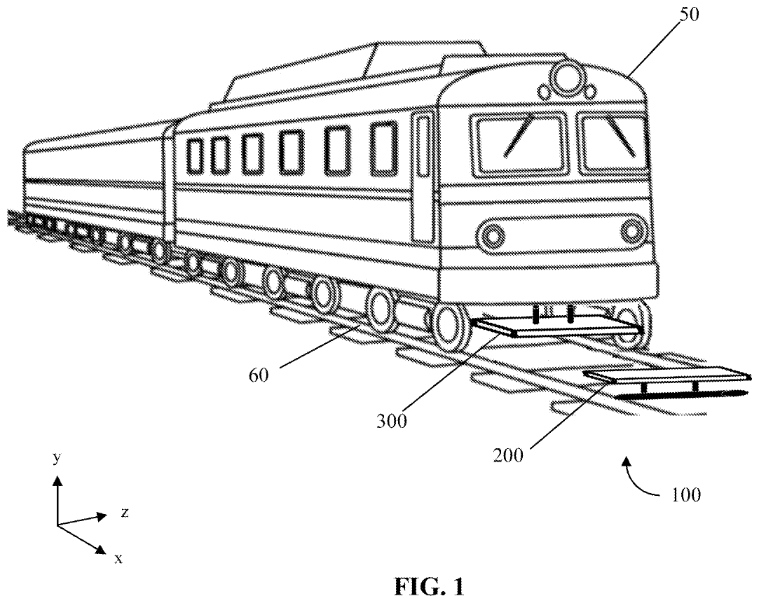

The invention described herein relates to a wireless charging system that facilitates the wirelessly charging of a battery of a railway vehicle without requiring any modification to the existing infrastructure by using a primary coil apparatus (or assembly) installed between the tracks on a railway and a secondary coil apparatus (or assembly) installed on the bottom side of a railway vehicle. For example, FIG. 1 depicts a perspective view of a wireless charging system 100 installed on a railway, according to one or more aspects described herein. In various embodiments, wireless charging system 100 may be configured to wirelessly charge a battery (and/or other power source or power supply) of a railway vehicle, such as a battery-operated locomotive, a railcar mover, and/or one or more other types of railway vehicles. In various embodiments, wireless charging system 100 may include at least a primary coil assembly 200 and a secondary coil assembly 300. In various embodiments, primary coil assembly 200 (which may also be interchangeably referred to herein as the “fixed coil assembly”) may be installed between the tracks 60 on a railway. In various embodiments, secondary coil assembly 300 (which may also be interchangeable referred to herein as the “mobile coil assembly”) may be installed on the bottom side of a railway vehicle 50.

In some embodiments, components of wireless charging system 100 may be welded or securely fixed to rail tracks 60. Alternatively, in some embodiments, components of wireless charging system 100 may be press fit using fastening techniques that does not require welding or holes on rail tracks. For example, components of wireless charging system 100 (e.g., primary coil assembly 200, described further herein) may be pressure mounted between tracks on a set of rail tracks 60. As depicted in FIG. 1, wireless charging system 100 may comprise a primary coil assembly 200 detachably (or selectively) installed between the rail tracks 60 via various fastening mechanisms and a secondary coil assembly 300 fixedly installed on the railway vehicle 50. As depicted in FIG. 1, rail tracks 60 are described herein as extending along a rail-extending plane (i.e., x-z plane), and wireless charging occurs perpendicular to the rail-extending plane along the y-axis.

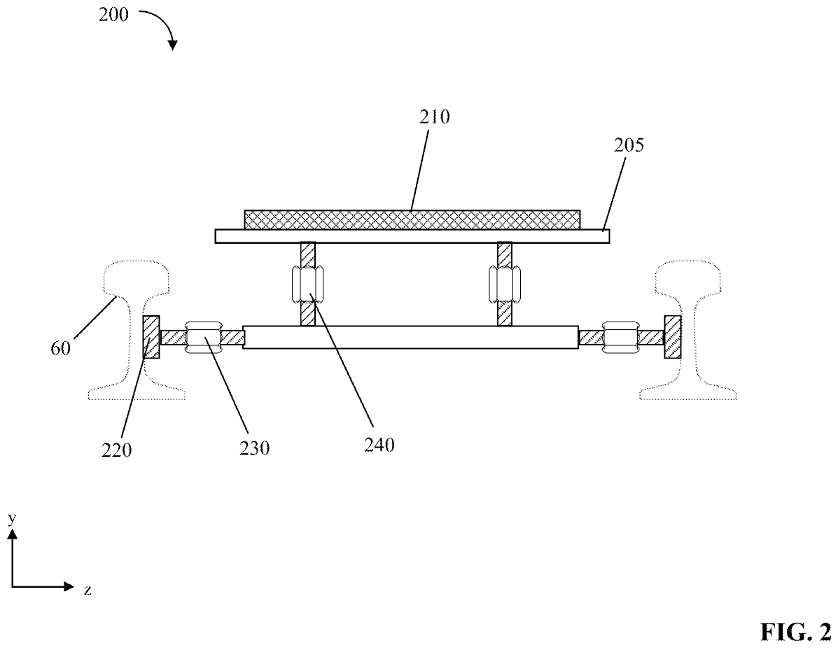

FIG. 2 depicts a front view of a primary coil assembly 200 installed between the tracks on a railway, according to one or more aspects described herein. In various embodiments, primary coil assembly 200 may comprise at least one primary coil 210 mounted on a base 205 that includes mounting member 220, one or more horizontal adjustment portions 230, vertical adjustment portions 240, and/or one or more other components. Primary coil 210 may also be interchangeably referred to herein as “fixed coil 210” for at least the reason that primary coil 210 is detachably installed between a set of tracks. In various embodiments, primary coil assembly 200 may be detachably (or selectively) installed anywhere between the rail tracks 60. The horizontal adjustment portions 230 may provide horizontal pressure to support base 205 (and at least one primary coil 210 thereon) until it is at adequate pressure that the primary coil assembly 200 does not become dislodged. As depicted in FIG. 2, primary coil assembly 200 may be detachably (or selectively) affixed to rail tracks 60 via the mounting member 220.

In various embodiments, at least one primary coil 210 may be securely mounted on base 205 configured to be positioned between the rail tracks 60. The position of base 205 may be adjusted using horizontal adjustment portions 230 and/or vertical adjustment portions 240. For example, the horizontal adjustment portions 230 and/or vertical adjustment portions 240 may comprise threaded rods, hex coupling nuts, and/or other types of threaded rods configured to affix mounting member 220 to rail tracks 60.

In various embodiments, mounting member 220 may be configured to securely attach base 205 (and primary coil assembly 200) to the rail tracks 60. In various embodiments, mounting member 220 may be rigidly mounted to a side of rail via selectively detachable fasteners using a compression mechanism. In various embodiments, mounting member 220 may be configured to securely attach primary coil assembly 200 to rail tracks 60 by one or more fastening techniques describes herein or otherwise known or future developed. For example, a compression flange may be utilized on a side of rail 60 to attach mounting member 220 to rail tracks 60. While mounting member 220 is described herein, it should be understood that a combination of features may be used to secure primary coil assembly 200 to rail tracks 60.

In some embodiments, primary coil assembly 200 may further include one or more reinforcing components configured to secure primary coil assembly 200 to rail tracks 60. For example, in some embodiments, one or more reinforcing components may be configured to secure base 205 to rail tracks 60 along lower portions of rail tracks 60 and inside of rail tracks 60. In some embodiments, one or more reinforcing components may be configured to cover lower portions of rail tracks 60 to improve vertical stability of primary coil assembly 200 with respect to rail tracks 60.

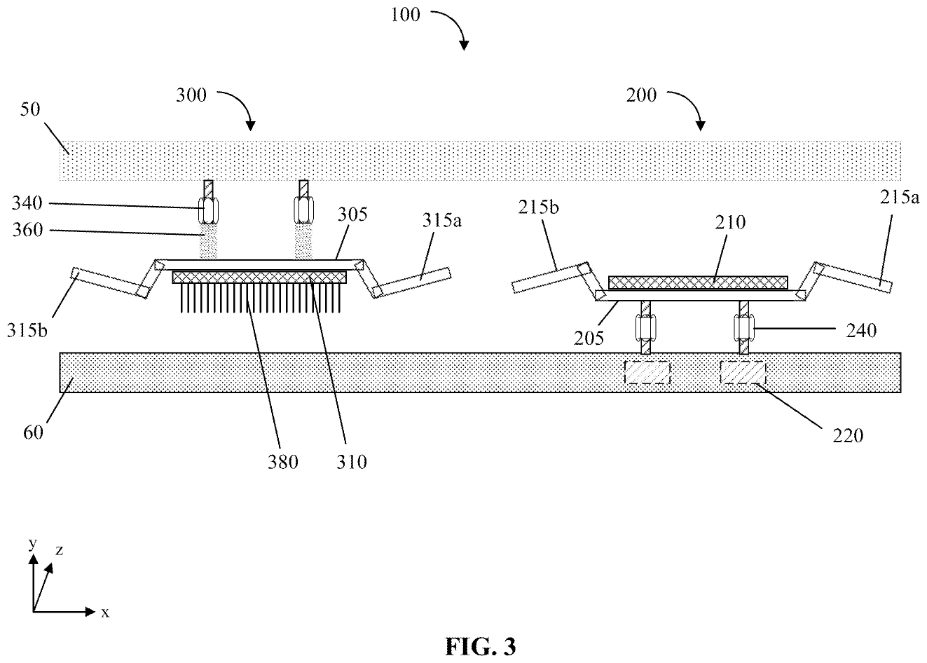

FIG. 3 depicts a side view of wireless charging system 100 comprising primary coil assembly 200 installed between the tracks 60 on a railway and a secondary coil assembly 300 affixed to the bottom of a railway vehicle 50, according to one or more aspects described herein. In various embodiments, second coil assembly 300 may comprise at least one secondary coil 310 mounted on a base 305, one or more vertical adjustment portions 340, and/or one or more other components. Secondary coil 310 may also be interchangeably referred to herein as “mobile coil 310” for at least the reason that secondary coil 310 is attached to a railway vehicle that moves with respect to primary coil assembly 200. In various embodiments, secondary coil 310 may be suspended from a bottom side of railway vehicle 50. In various embodiments, secondary coil assembly 300 may be positioned or oriented such that secondary coil 310 is oriented parallel to primary coil 210.

In various embodiments, at least one primary coil 210 of primary coil assembly 200 may be mounted on base 205 “horizontally” (i.e., on the x-z plane) such that primary coil 210 may be facing upwardly and generally parallel to at least one secondary coil 310 mounted on a base 305 of secondary coil assembly 300. In various embodiments, vertical adjustment portions 240 and vertical adjustment portions 340 may be positioned to allow primary coil 210 mounted on base 205 and secondary coil 310 mounted on base 305 to be adjusted to or within a relatively parallel position (e.g., to improve conditions for transferring power from the primary coil assembly 200 to secondary coil assembly 300). For example, as depicted in FIGS. 2-3, vertical adjustment portions 240 and vertical adjustment portions 340 may be positioned with a hex coupling nut and a threaded rod to move base 205 or base 305, respectively.

As depicted in FIG. 3, base 205 of primary coil assembly 200 may include one or more slide portions 215a, 215b. In various embodiments, secondary coil assembly 300 may similarly comprise at least one secondary coil 310 mounted on a base 305 that includes slide portions 315a, 315b. In some embodiments, secondary coil assembly 300 may include vertical adjustment portions 340, a biasing component 360, a brush 380, and/or one or more other components. In various embodiments, secondary coil assembly 300 may be installed on or affixed to a bottom side of railway vehicle 50 and enable railway vehicle 50 receive power transferred from primary coil assembly 200 (e.g., to charge a battery of railway vehicle 50).

One aspect of the disclosure is that wireless charging system 100 may be configured to adjust a distance between the at least one primary coil 210 and the at least one secondary coil 310 automatically without any modification to the existing infrastructure. In various embodiments, base 205 of primary coil assembly 200 may include slide portions 215a, 215b. In some embodiments, the slide portions 215a, 215b may be symmetrical in shape. In other embodiments, the slide portions 215a, 215b may be asymmetrical in shape. In various embodiments, base 305 of secondary coil assembly 300 may similarly include slide portions 315a, 315b. In some embodiments, slide portions 315a, 315b may be symmetrical in shape. However, in other embodiments, slide portions 315a, 315b may be asymmetrical in shape.

In various embodiments, slide portions 215a, 215b may be bent to form a v-shaped base 205 that allows base 205 to include a different height at different points along base 205. Similarly, slide portions 315a, 315b may be bent to form a v-shaped base 305 that allows base 305 to include a different height at different points along base 305. By utilizing a combination of the different levels of height created by v-shaped base 205 and v-shaped base 305, wireless charging system 100 may be configured to position primary coil 210 underneath secondary coil 310 so that a distance between primary coil 210 and secondary coil 310 is automatically adjusted only based on mechanical means without any modification to the existing infrastructure.

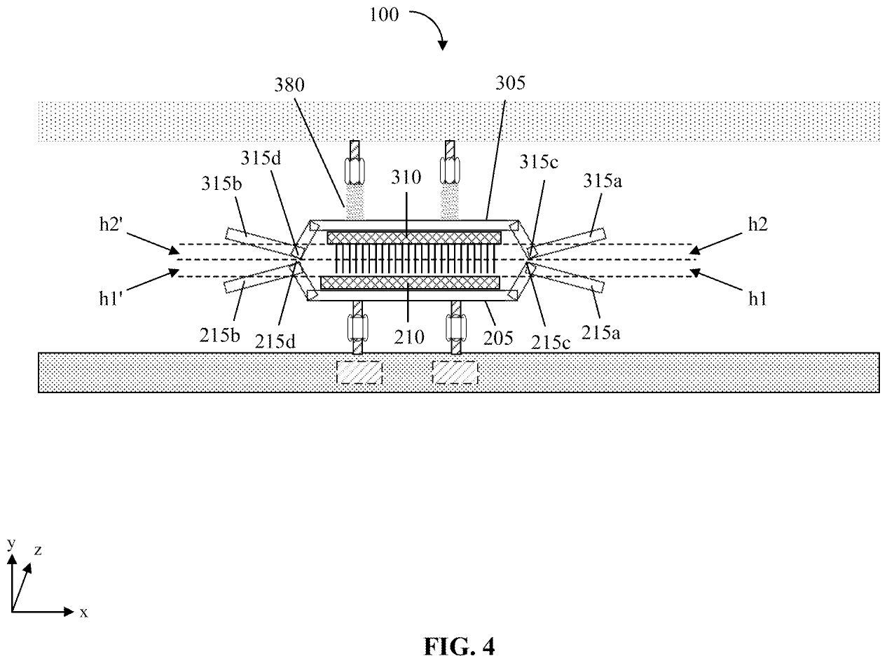

As depicted in FIG. 3, in operation, slide portion 315a of secondary coil assembly 300 may be configured to slidably or wedgingly engage slide portion 215b of primary coil assembly 200, so that a distance between the primary coil assembly 200 and the secondary coil assembly 300 can be adjusted automatically without any modification to the existing infrastructure. For example, when the train approaches a charging station/area where the primary coil assembly 200 is detachably (or selectively) installed, if the primary coil assembly 200 and the secondary coil assembly 300 are too close to each other, secondary coil assembly 300 may come in contact with primary coil assembly 200, force the secondary coil assembly 300 away from the primary coil assembly 200, and then adjust a distance between at least one primary coil 210 of the primary coil assembly 200 and at least one secondary coil 310 of the secondary coil assembly 300 to a predetermined distance (e.g., air gap heights h1, h1′, h2 and h2′ depicted in FIG. 4). As described herein, wireless charging system 100 may be configured to transfer power from the primary coil assembly 200 installed between the rail tracks 60 to secondary coil assembly 300 without physically contacting each other (i.e., charging wirelessly). In such embodiments, one or more slide portions 215 and 315 of wireless charging system 100 may provide a novel mechanical only (without sensors) geometry or solution previously unseen in the railcar industry.

Another aspect of the disclosure is that wireless charging system 100 may include a brush 380 installed on the secondary coil assembly 300 to ensure optimal charging environment when transferring power from primary coil 210 to secondary coil 310. As the train including brush 380 approaches a charging station/area where the primary coil assembly 200 is detachably (or selectively) installed, brush 380 may remove (or brush away) any debris on a surface of primary coil 210, which may interfere with the transfer of power from primary coil 210 to secondary coil 310 without physically contacting each other.

Areas proximate to railways can be harsh environments in which electrical components (such as primary coil 210) may be exposed to stone, steel, dirt and/or dust. Indeed, such a harsh environment may affect the performance and/or longevity of the primary coil assembly 200. In various embodiments, by positioning brush 380 beneath a bottom side of base 305, wireless charging system 100 may provide a more optimal charging environment when transferring power within the harsh environment in which wireless charging system 100 is utilized. Accordingly, brush 380 may increase the reliability of primary coil assembly 200 by cleaning any debris and reducing exposure to the primary coil 210 mounted (and used) in a potentially harsh environment.

In various embodiments, primary coil 210 and/or secondary coil 310 (shown in FIG. 3) may be configured to include a generally rectangular shape from a rail-extending plane (i.e., x-z plane), as better depicted in FIG. 1. However, primary coil 210 and/or secondary coil 310 may be a circular, non-circular, polygonal, triangular, oval, or a combination of any appropriate shape to facilitate the one or more features or functionality of wireless charging system 100 described herein.

In various embodiments, primary coil 210 may include a single primary coil 210 or a combination of any appropriate number and/or size to facilitate the one or more features or functionality of wireless charging system 100 described herein. Similarly, in various embodiments, secondary coil 310 may include a single secondary coil 310 or a combination of any appropriate number and/or size to facilitate the one or more features or functionality of wireless charging system 100 described herein.

In various embodiments, base 205 may comprise a generally similar surface profile throughout base 205. In some embodiments, base 205 may further include one or more portions with a varying profile. For example, the varying profile may be present proximate to slide portions 215a, 215b and/or slide portions 315a, 315b to reduce friction extending along the x- and/or z-axes when slide portions 215a, 215b and slide portions 315a, 315b may be configured to slidably or wedgingly engage each other and to position at least one primary coil 210 and at least one secondary coil 310 facing generally parallel to each other at a predetermined distance.

FIG. 4 depicts another side view of wireless charging system 100, according to one or more aspects described herein. For example, FIG. 4 depicts primary coil assembly 200 and secondary coil assembly 300 when secondary coil 310 is positioned to receive power transferred from primary coil 210. In various embodiments, base 205 may comprise air gap heights h1 and h1′. Air gap height h1 may be defined by a distance between inflection point 215c of slide portions 215a and a top surface of at least one primary coil 210. Air gap height h1′ may be defined by a distance between inflection point 215d of slide portions 215b and a top surface of at least one primary coil 210. In an embodiment that includes symmetrical slide portions 215a, 215b, air gap heights h1, h2 may be similar in length and may be, for example, between 7-13 mm. In a particular example embodiment, air gap heights h1, h2 are 10 mm in length.

In various embodiments, base 305 may comprise air gap heights h2 and h2′. Air gap height h2 may be defined by a distance between inflection point 315c of slide portions 315a and a top surface of at least one secondary coil 310. Air gap height h2′ may be defined by a distance between inflection point 315d of slide portions 315b and a top surface of at least one secondary coil 310. In an embodiment that includes symmetrical slide portions 315a, 315b, air gap heights h2 and h2′ may be similar in length and may be, for example, between 7-13 mm. In a particular example embodiment, air gap heights h2 and h2′ are 10 mm in length.

As the train approaches a charging station/area where the primary coil assembly 200 is detachably (or selectively) installed, if the primary coil assembly 200 and the secondary coil assembly 300 are at a desired (appropriate for wireless charging) height, slide portions 315a of the secondary coil assembly 300 will not collide or come in contact with slide portions 215b of the primary coil assembly 200. In such embodiments, desired air gap between a top surface of at least one primary coil 210 and bottom surface of at least one secondary coil 310 may be, for example, roughly 20 mm in length.

In various embodiments, secondary coil assembly 300 may include a biasing component 360 configured to work together with slide portions 215a, 215b and slide portions 315a, 315b utilizing a combination of the different levels of height created by v-shaped base 205 and v-shaped base 305. For example, if primary coil assembly 200 is not at a desired height (i.e., lower than a portion of secondary coil assembly 300), biasing component 360 may prevent a collision of the secondary coil assembly 300 against primary coil assembly 200. In some embodiments, biasing component 360 may allow secondary coil assembly 300 attached to the train to move upwards in response to contact with slide portions 215a, 215b of primary coil assembly 200, and then allow secondary coil assembly 300 to come back down and maintain an air gap between the secondary coil assembly 300 and the primary coil assembly 200. In various embodiments, biasing component 360 may comprise a spring. For example, biasing component 360 may comprise a wave spring, a compression force spring, or any other suitable type of spring.

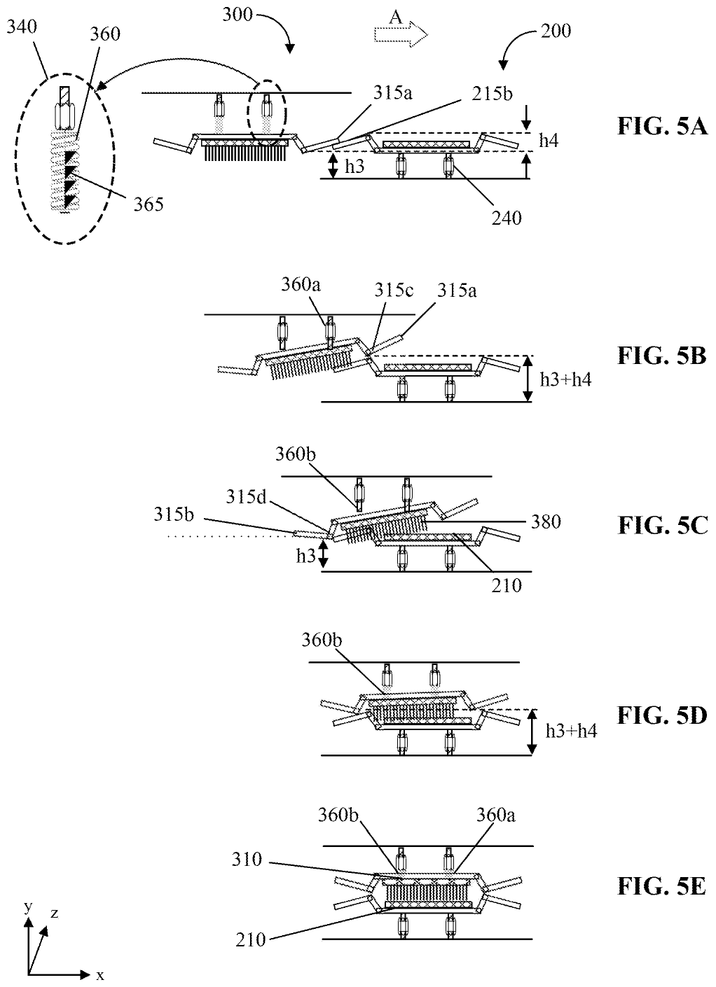

FIGS. 5A-E depict various views of wireless charging system 100, according to one or more aspects described herein. In alternative embodiments, vertical adjustment portions 340 of secondary coil assembly 300 may include a linear ratchet mechanism 365 configured to allow linear motion in only one direction working together with the biasing component 360, when they are compressed. For example, as depicted in FIG. 5A, the vertical adjustment portions 340 may be configured to include a series of axially arranged wedge lock teeth provided along an axis of the biasing component 360 (i.e., vertical adjustment portions 340). In such embodiments, a linear ratchet mechanism 365 may further include an unlatching mechanism to allow linear motion in both directions working together with biasing component 360, when they are compressed.

In various embodiments, as depicted in FIG. 5A, base 205 may comprise a level of height h3 created by vertical adjustment portions 240 and another level of height h4 created by slide portions 215b. As the train approaches a charging station/area where primary coil assembly 200 is detachably (or selectively) installed, if primary coil assembly 200 and secondary coil assembly 300 are too close to each other, slide portions 315a of secondary coil assembly 300 may come in contact with slide portions 215b of primary coil assembly 200.

As depicted in FIG. 5B, in various embodiments, slide portions 315a may wedgingly engage slide portions 215b and slidably move secondary coil assembly 300 away from primary coil assembly 200 until a lowest point of slide portions (i.e., inflection point 315c) reaches a level of height h3+h4 created by vertical adjustment portions 315a and slide portions 215b. In such a case, the linear ratchet mechanism provided along an axis of the biasing component 360a may lock position of the biasing component 360a at the level of height h3+h4 created by vertical adjustment portions 315a and slide portions 215b.

As depicted in FIG. 5C, in various embodiments, as slide portions 315b may wedgingly engage slide portions 215b and slidably move secondary coil assembly 300 away from primary coil assembly 200. In such a case, the linear ratchet mechanism provided along an axis of the biasing component 360b may lock position of the biasing component 360b at the level of height h3+h4 created by vertical adjustment portions 315b and slide portions 215b. Additionally, the brush 380 may be configured to brush away any debris that might have gotten on a surface of primary coil 210, which may interfere transferring power from primary coil 210 to secondary coil 310 without physically contacting each other.

As depicted in FIG. 5D, in various embodiments, as slide portions 315b may slidably move secondary coil assembly 300 away from primary coil assembly 200 until a lowest point of slide portions (i.e., inflection point 315d) reaches a level of height h3+h4 created by vertical adjustment portions 315a and slide portions 215b. In such a case, the linear ratchet mechanism provided along an axis of the biasing component 360b may lock position of the biasing component 360b at the level of height h3+h4 created by vertical adjustment portions 315b and slide portions 215b.

Finally, as depicted in FIG. 5E, in various embodiments, slide portions 215a, 215b and slide portions 315a, 315b may wedgingly engage corresponding portions, one another, and slidably position primary coil 210 and secondary coil 310 facing generally parallel to each other at a predetermined distance. By utilizing combination of the different level of height h3, h4 created by v-shaped base 205 and v-shaped base 305 and biasing component 360a, 360b including a linear ratchet mechanism 365, wireless charging system 100 can position primary coil 210 underneath secondary coil 310 so that a distance between primary coil 210 and secondary coil 310 are automatically adjusted only based on mechanical means without any modification to the existing infrastructure.

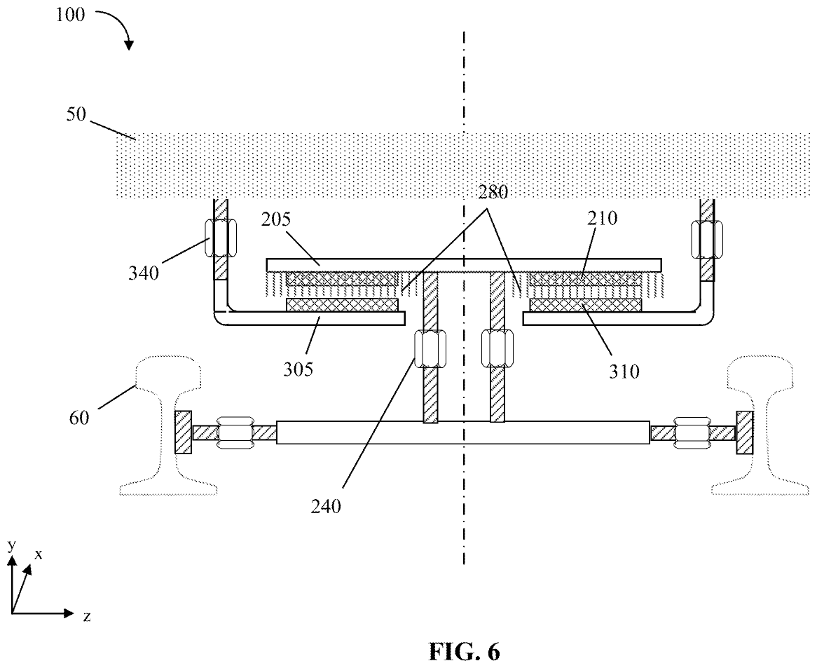

FIG. 6 depicts a front view of an alternative embodiment of wireless charging system 100, according to one or more aspects described herein. In an alternative embodiment, as shown in FIG. 6, primary coil 210 of primary coil assembly 200 may be mounted on a bottom side of base 205 such that the at least one primary coil 210 may be facing downwardly and generally parallel to at least one secondary coil 310 mounted on a top side of base 305. In various embodiments, vertical adjustment portions 240 may extend further away (passing base 305) from a ground to allow primary coil 210 to be positioned above the at least one secondary coil 310 in a charging position. In such embodiments, the wireless charging system 100 may include a brush 280 mounted to base 205 of primary coil assembly 200. The brush 280 may be configured to brush away any debris that might have gotten on a surface of the at least one secondary coil 310, which may interfere with the transfer of power from primary coil 210 to secondary coil 310.

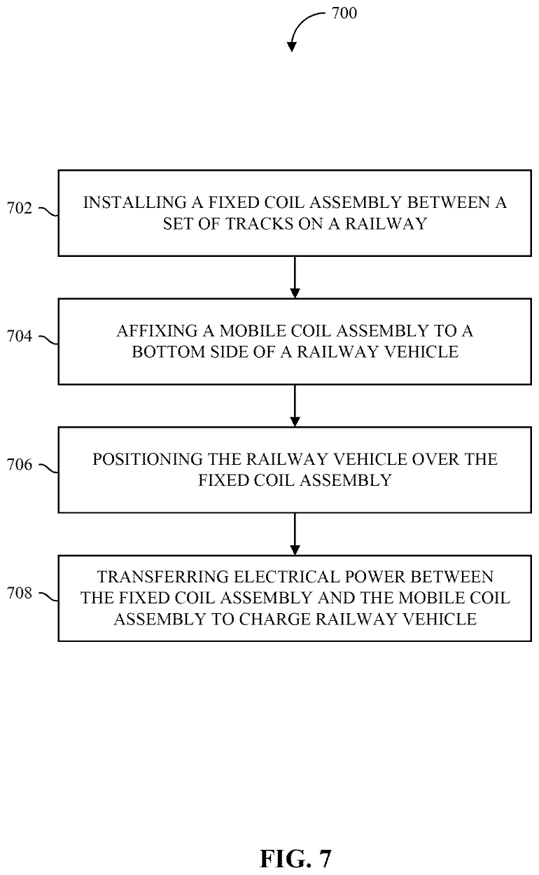

FIG. 7 illustrates an example of a process 700 for wirelessly charging a battery of a railway vehicle, according to one or more aspects described herein. The operations of process 700 presented below are intended to be illustrative and, as such, should not be viewed as limiting. In some implementations, process 700 may be accomplished with one or more additional operations not described, and/or without one or more of the operations discussed. In some implementations, two or more of the operations of process 700 may occur substantially simultaneously. The described operations may be accomplished using some or all of the system components described in detail above. In various embodiments, process 700 may be performed using some or all of the components of wireless charging system 100 described herein.

In an operation 702, process 700 may include installing a fixed coil assembly between a set of tracks of a railway. In various implementations, the fixed coil assembly comprises a primary coil. In various implementations, the fixed coil assembly may be detachably installed between the set of tracks. For example, the fixed coil assembly may be pressure mounted between the set of tracks of the railway. In various implementations, the primary coil may be mounted on a base of the fixed coil assembly, and the fixed coil assembly may comprise one or more adjustment portions configured to adjust a position of the base between the set of tracks of the railway. In some implementations, the fixed coil assembly may further comprise mounting members configured to interface with an interior side of each of the set of tracks of the railway. The fixed coil assembly may include a single primary coil or multiple coils including at least the primary coil.

In an operation 704, process 700 may include affixing a mobile coil assembly to a bottom side of a railway vehicle. In various implementations, the mobile coil assembly comprises a secondary coil. In various implementations, the railway vehicle may comprise a locomotive, a railcar mover, and/or another type of railway vehicle configured to move on tracks of a railway. In various implementations, the secondary coil may be mounted on a base of the mobile coil assembly, and the mobile coil assembly may comprise one or more adjustment portions configured to adjust a position of the base relative to the bottom side of the railway vehicle. In various implementations, the secondary coil may be suspended from the bottom side of the railway vehicle and oriented parallel to the primary coil. In some implementations, the mobile coil assembly may comprise a brush configured to remove debris on a surface of the primary coil as a railway vehicle passes over a fixed coil assembly. The mobile coil assembly may include a single secondary coil or multiple coils including at least the secondary coil.

In an operation 706, process 700 may include positioning the railway vehicle over the fixed coil assembly. When the railway vehicle is positioned over the fixed coil assembly, the mobile coil assembly may be configured to interface with or move within a proximity of the fixed coil assembly. In some implementations, the primary coil of the fixed coil assembly may be oriented such that it faces upward away from the tracks of the railway. In such implementations, the secondary coil may be oriented such that it faces downward away from the bottom side of the railway vehicle, and thus may face toward the primary coil. In other implementations, the primary coil of the fixed coil assembly may be oriented such that it faces downward towards the tracks of the railway. In such implementations, the secondary coil may be oriented such that it faces upward towards the bottom side of the railway vehicle, and thus may face toward the primary coil. In some implementations, the fixed coil assembly and the mobile coil assembly may each comprise one or more slide portions. In such implementations, at least one slide portion of the mobile coil assembly may be configured to engage at least one slide portion of the fixed coil assembly to adjust (or maintain) a distance between the primary coil and the secondary coil.

In an operation 708, process 700 may include transferring electrical power between the fixed coil assembly and the mobile coil assembly to charge the railway vehicle. In various implementations, electrical power may be transferred via the primary coil and the secondary coil without the primary coil physically contacting the secondary coil. In various implementations, the fixed coil assembly may be configured to wireless charge the railway vehicle. In various implementations, wirelessly charging the vehicle via the fixed coil assembly would comprise inductive charging. For example, in various implementations, a current may be passed through the primary coil at the fixed coil assembly to create an electromagnetic field. The electromagnetic field created by the primary coil of the fixed coil assembly may create an alternating electric current in the secondary coil of the mobile coil assembly, which may in turn be used to charge a battery or other power source/supply of the railway vehicle.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one embodiment”, “an embodiment”, “some embodiments”, “various embodiments”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A system for wirelessly charging a battery of a railway vehicle comprising:
a fixed coil assembly installed between a set of tracks of a railway, the fixed coil assembly comprising a primary coil; and
a mobile coil assembly affixed to a bottom side of a railway vehicle, the mobile coil assembly comprising a secondary coil,
wherein when the railway vehicle is positioned over the fixed coil assembly, the fixed coil assembly is configured to transfer electrical power to the mobile coil assembly via the primary coil and the secondary coil without the primary coil physically contacting the secondary coil.

2. The system of claim 1, wherein the railway vehicle comprises a locomotive.

3. The system of claim 1, wherein the railway vehicle comprises a railcar mover.

4. The system of claim 1, wherein the fixed coil assembly is detachably installed between the set of tracks.

5. The system of claim 4, wherein the fixed coil assembly is pressure mounted between the set of tracks of the railway.

6. The system of claim 1, wherein the primary coil is mounted on a base of the fixed coil assembly, and wherein the fixed coil assembly comprises one or more adjustment portions configured to adjust a position of the base between the set of tracks of the railway.

7. The system of claim 6, wherein the fixed coil assembly further comprises mounting members configured to interface with an interior side of each of the set of tracks of the railway.

8. The system of claim 1, wherein the secondary coil is mounted on a base of the mobile coil assembly, and wherein the mobile coil assembly comprises one or more adjustment portions configured to adjust a position of the base relative to the bottom side of the railway vehicle.

9. The system of claim 1, wherein the secondary coil is suspended from the bottom side of the railway vehicle and oriented parallel to the primary coil.

10. The system of claim 1, wherein the fixed coil assembly and the mobile coil assembly each further comprise one or more slide portions, wherein at least one slide portion of the mobile coil assembly is configured to engage at least one slide portion of the fixed coil assembly to adjust a distance between the primary coil and the secondary coil.

11. The system of claim 1, wherein the mobile coil assembly further comprises a brush configured to remove debris on a surface of the primary coil as the railway vehicle passes over the fixed coil assembly.

12. The system of claim 1, wherein the fixed coil assembly comprises one or multiple coils including at least the primary coil, and wherein the mobile coil assembly comprises one or multiple coils including at least the secondary coil.

13. The system of claim 1, wherein the primary coil faces upward away from the tracks of the railway, and wherein the secondary coil faces downward away from the bottom side of the railway vehicle.

14. The system of claim 1, wherein the primary coil faces downward towards the tracks of the railway, and wherein the secondary coil faces upward towards the bottom side of the railway vehicle.

15. A method of wirelessly charging a battery of a railway vehicle, the method comprising:
installing a fixed coil assembly between a set of tracks of a railway, the fixed coil assembly comprising a primary coil;
affixing a mobile coil assembly to a bottom side of a railway vehicle, the mobile coil assembly comprising a secondary coil;
positioning the railway vehicle over the fixed coil assembly; and
transferring electrical power between the fixed coil assembly and the mobile coil assembly to charge the railway vehicle.
